(19) United States
(12) Patent Application Publication
(10) Pub. No.: US 2014/0181646 A1
(43) Pub. Date: Jun. 26, 2014

(54) DYNAMIC LAYOUT SYSTEM FOR REMOTE CONTENT

(71) Applicant: MICROSOFT CORPORATION, Redmond, WA (US)

(72) Inventors: Tasneem Abdulali Rangwala, Sunnyvale, CA (US); Naeim Semsarilar, San Carlos, CA (US); Tony Ran Zhang, San Jose, CA (US); Hadi Moustafa Abou El-Kheir, Santa Clara, CA (US)

(73) Assignee: MICROSOFT CORPORATION, Redmond, WA (US)

(21) Appl. No.: 13/721,385

(22) Filed: Dec. 20, 2012

(51) Int. Cl. G06F 17/21

(52) U.S. Cl. CPC G06F 17/212
USPC 715/252

(57) ABSTRACT

Embodiments of the present invention build content summaries and summary clusters, which are collections of content summaries arranged in a visually appealing way. Individual content summaries may include a picture, a headline, a snippet, a publication date, a source, a byline, a headline, and other descriptors. Exemplary content includes articles, videos, slideshows, and advertisements. In addition, dynamic content presentations may also be generated by embodiments of the present invention. A content presentation arranges text, images and other content into a cohesive presentation that may be several pages long. The dynamic content presentation allows content text and images to be presented on displays having a variety of different resolutions.

### BACKGROUND

A proliferation of content available through the Internet and other sources. Content aggregators select content of interest and present it to a user. Groups of content may be presented together in a list or other arrangement. Once selected the individual content, such as a news article, is presented to the user for consumption.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the present invention build content summaries and summary clusters, which are collections of content summaries arranged in a visually appealing way. Individual content summaries may include a picture, a headline, a snippet, a publication date, a source, a byline, a headline, and other descriptors. Exemplary content includes articles, videos, slideshows, and advertisements. The content summary and summary cluster may be built on a client device using summary information received from a content aggregator or content manager.

In addition to building summaries and summary clusters, dynamic content presentations may also be generated by embodiments of the present invention. A content presentation arranges text, images and other content into a cohesive presentation that may be several pages long. The dynamic content presentation allows content text and images to be presented on displays having a variety of different resolutions. In addition, different dynamic arrangements may be generated based on whether the device is in a portrait or landscape orientation.

### BRIEF DESCRIPTION OF THE DRAWINGS

Embodiments of the invention are described in detail below with reference to the attached drawing figures, wherein:

FIG. 1 is a block diagram of an exemplary computing environment suitable for implementing embodiments of the invention;

FIG. 2 is a diagram of remote computing environment, in accordance with an embodiment of the present invention;

FIG. 3 is a diagram of a content management environment, in accordance with an embodiment of the present invention;

FIG. 4 is a diagram showing components of a summary-cluster component, in accordance with an embodiment of the present invention;

FIG. 5 is a diagram showing an exemplary summary cluster, in accordance with an embodiment of the present invention;

FIG. 6 is a diagram showing an exemplary summary cluster, in accordance with an embodiment of the present invention;

FIG. 7 is a flow chart showing a method of generating a user interface for displaying a plurality of content summaries, in accordance with an embodiment of the present invention;

FIG. 8 is a diagram of a content-layout component, in accordance with an embodiment of the present invention;

FIG. 9 is a diagram showing column components and order, in accordance with an embodiment of the present invention;

FIG. 10 is a diagram showing an exemplary article presentation, in accordance with an embodiment of the present invention;

FIG. 11 is a diagram showing an exemplary article presentation, in accordance with an embodiment of the present invention;

FIG. 12 is a flow chart showing a method of generating an article presentation, in accordance with an embodiment of the present invention;

FIG. 13 is a table showing column widths that would result when the landscape oriented display is divided into various numbers of columns, in accordance with an embodiment of the present invention; and

FIG. 14 is a column widths that would result when the portrait oriented display is divided into various numbers of columns, in accordance with an embodiment of the present invention.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention build content summaries and summary clusters, which are collections of content summaries arranged in a visually appealing way. Individual content summaries may include a picture, a headline, a snippet, a publication date, a source, a byline, a headline, and other descriptors. Exemplary content includes articles, videos, slideshows, and advertisements. The content summary and summary cluster may be built on a client device using summary information received from a content aggregator or content manager.

An individual content summary is generated based on characteristics of summary information associated with the content and with a view towards its place in a summary cluster. For example, an appropriate summary template, which is used to build the summary, may be selected based on the size of an image, length of a snippet and characteristics of summary information.

In one embodiment, the summary templates are grouped into multiple template classes, each class having templates adapted for summary information with similar characteristics. The first step in generating a content summary is to select the appropriate class of templates. The class of template may be selected based on the image size, snippet length, and other factors. Within the class, multiple templates designed for optimal presentation of summary information having the associated characteristics are available for selection.

The template within the class may be selected by using rules designed to enhance the appearance of the overall summary cluster. For example, a selected template may need to satisfy a frequency rule that specifies that a template may only appear once every N times within the dynamic cluster. Another rule limits use of a template to use once every N columns within the summary cluster. In addition to frequency rules, the position of the summary within the summary cluster may be considered using a position rule. The position rule favors templates that will have the best fit within the available space. Finally, if only one template will fit within the available space it will be selected even if the other rules are violated. Other rules may be incorporated and given various priority over one another to generate summary cluster. This template selection process may be repeated for each summary added to the cluster.

In addition to building summaries and summary clusters, dynamic content presentations may also be generated by embodiments of the present invention. A content presentation arranges text, images and other content into a cohesive presentation that may be several pages long. The dynamic content presentation allows content text and images to be presented on displays having a variety of different resolutions. In addition, different dynamic arrangements may be generated based on whether the device is in a portrait or landscape orientation.

The arrangement initially selects the ideal column size and number of columns based on the screen resolution and orientation. Once the size of the column and columns per page are selected, then the total number of columns needed to present the article and images or other media associated with the article is determined. Once the total size of the article is determined, as measured in the total number of columns and pages, then the images in the article are placed within the layout. The images are place according to their size (aspect ratio). The text and other content is placed according to the image location. The text then flows around the images to generate a rendered article presentation. The article is output to the user for viewing.

Having briefly described an overview of embodiments of the invention, an exemplary operating environment suitable for use in implementing embodiments of the invention is described below.

### Exemplary Operating Environment

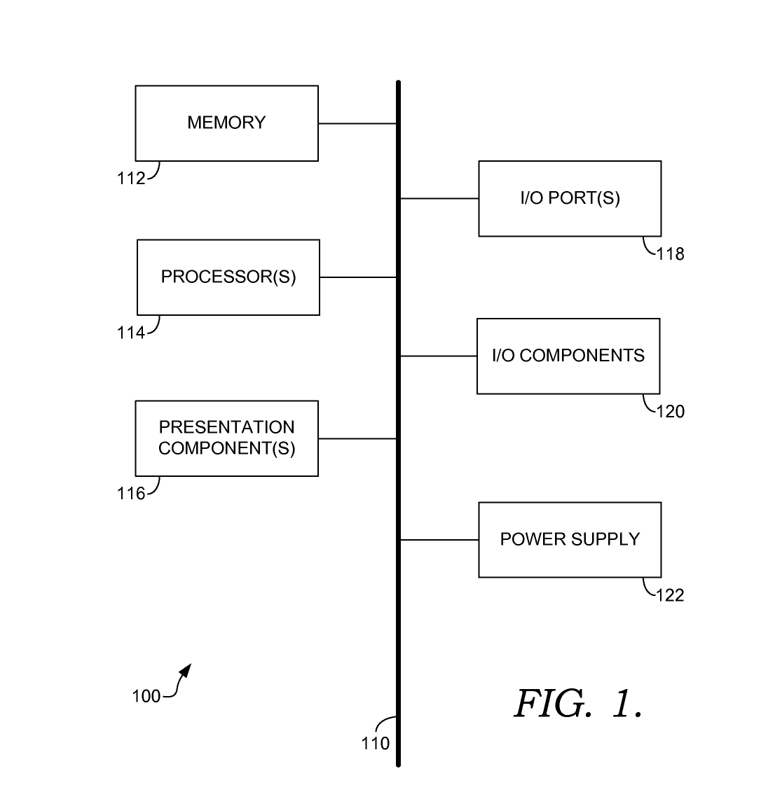

Referring to the drawings in general, and initially to FIG. 1 in particular, an exemplary operating environment for implementing embodiments of the invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Embodiments of the invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component 120. Also, processors have memory. The inventors hereof recognize that such is the nature of the art, and reiterate that the diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory 112 may be removable, nonremovable, or a combination thereof. Exemplary memory includes solid-state memory, hard drives, optical-disc drives, etc. Computing device 100 includes one or more processors 114 that read data from various entities such as bus 110, memory 112 or I/O components 120. Presentation component(s) 116 present data indications to a user or other device. Exemplary presentation components 116 include a display device, speaker, printing component, vibrating component, etc. I/O ports 118 allow computing device 100 to be logically coupled to other devices including I/O components 120, some of which may be built in. Illustrative I/O components 120 include a microphone, joystick, game pad, satellite dish, scanner, printer, wireless device, etc.

### Exemplary Remote Computing Environment

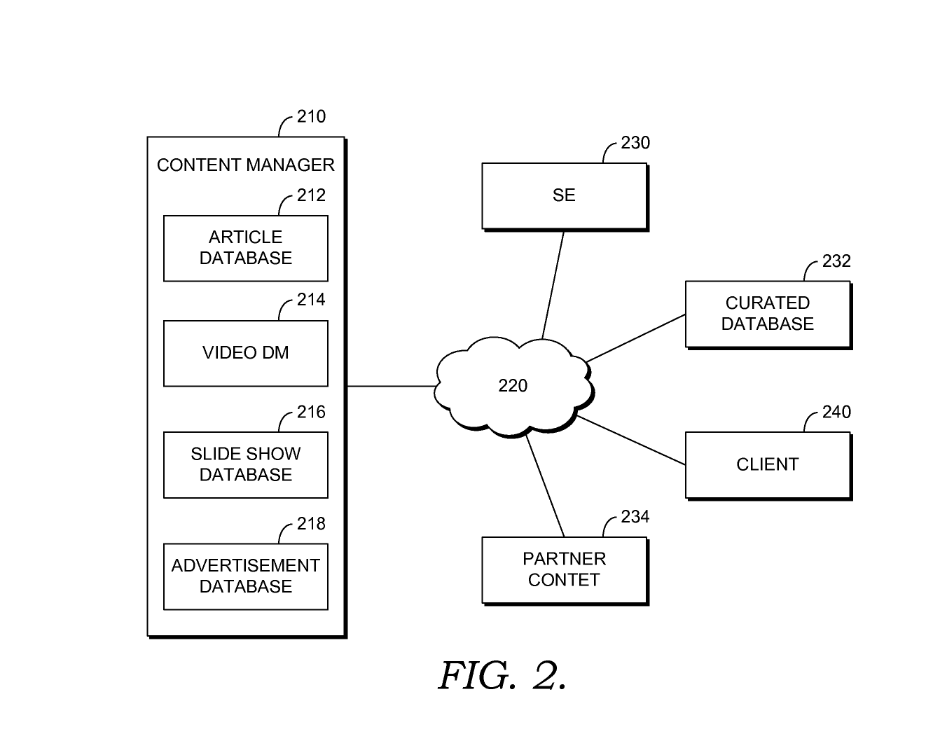

Turning now to FIG. 2, a remote computing environment for embodiments of the present invention is shown, in accordance with an embodiment of the present invention. Operating environment 200 includes a content manager 210 connected through network 220 to a search engine 230, a curated content database 232, partner content database 234, and client device 240.

The search engine 230 may gather content from a numerous sources. For example an index of news articles, sports articles, financial news, advertisements or other features may be cataloged by the search engine and communicated to the content manager 210.

The curated database 232 may similarly gather relevant content and communicate it to the content manager 210. A curated database 232 could include academic articles or other content that is selectively included within the database. The curated database may include articles that have been reviewed and edited by a curator.

The partner content database 234 may provide specialized content or content from a particular publisher. For example various news magazines or other publishing entities may make their content available to the content manager 210 so that it is more easily accessible to users.

The content manager 210 stores both content and an index of the content. Exemplary content databases include an article database 212, a video database 214, a slideshow database 216, and an advertising database 218. The content manager 210 may convert the content to a form that is consumable by applications on client device 240. For example, the text may be extracted and stored separately along with snippets, titles, images and other portions of the content. Each of these content portions may be consolidated by a client application into an arrangement that is displayed to the user. Using a central content manager 210 alleviates the need for the application on client device 240 to reformat data in for presentation. In addition to actually storing the content, the content may be described using metadata that is useful for generating summaries of the articles to be presented to the user.

The client 240 may be a computing device similar to the one described with reference to FIG. 1. Exemplary clients include a game console, a tablet or slate, and a personal computer. Use of other clients, such as smart phones and GPS devices, are also possible. The game console may have one or more game controllers communicatively coupled to it that may also provide user interfaces generated using remote templates. In one embodiment, the tablet may act as an input device for a game console or a personal computer, while running the same content application simultaneously. In another embodiment, the tablet is a stand-alone application client. In one embodiment, remote templates are pushed to the game console or PC and then to a companion device. The client device 240 may consume information from the content manager 210 to generate clusters of relevant content and arrange selected articles into a presentation.

### Exemplary Content Management

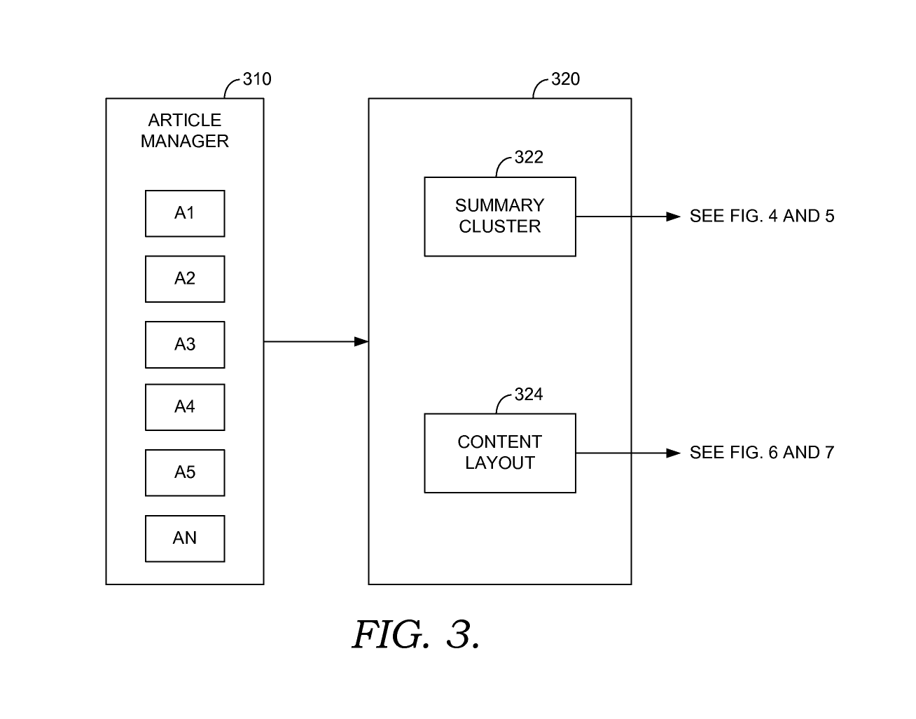

Turning now to FIG. 3, a content management environment 300 is illustrated according to an embodiment of the present invention. The content management environment 300 facilitates the organization, selection, and presentation of content to a user of a client device 320. The content management environment includes an article manager 310 and a client device 320. Content management environment 300 is merely an example of one suitable architecture and is not intended to suggest any limitation as to the scope of the use or functionality of the present invention. Neither should the content management environment 300 be interpreted as having any dependency or requirement related to any single component or combination of components illustrated therein.

The article manager 310 is responsible for collecting articles and organizing them for consumption by the client. The article manager 310 could be a portion of the content manager 210 described previously or a stand alone component. The article manager 310 is dedicated to managing articles, in contrast to videos, ads, etc. An individual content manager could have different components responsible for managing different types of content. In another embodiment, a single content manager manages multiple kinds of content. Articles are used as exemplary content in FIG. 3.

The article manager 310 includes articles A1, A2, A3, A4, A5 through AN. Each article may be associated with text, media, and metadata. The metadata may describe aspects of the article including publication date, author, source, keywords, headlines, length, and image sizes. Summary information for an article may also be stored as meta data. Summary data may comprise snippets that summarize a particular article, an abbreviated title or headline, an image, a source, a topic or category, and author.

The article manager 310 may periodically communicate summary information to the client 320 for display to a user. In one embodiment, the client 320 retrieves relevant article summaries upon a user opening an article browsing application. The article manager 310 may prioritize the importance or relevance of the article summaries displayed. The article manager 310 could sort articles by subject matter, timeliness, hot topics, popularity, and other factors based on an inference of the user's preferences or even by explicitly established user preferences. For example, a user could express interest in articles from a particular publication. As a result, new articles from that publication could be included preferentially in summaries provided.

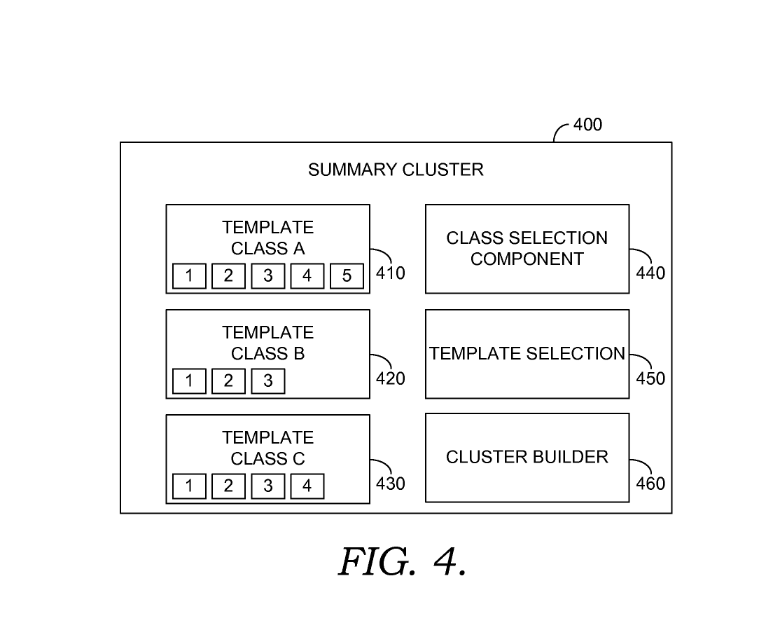

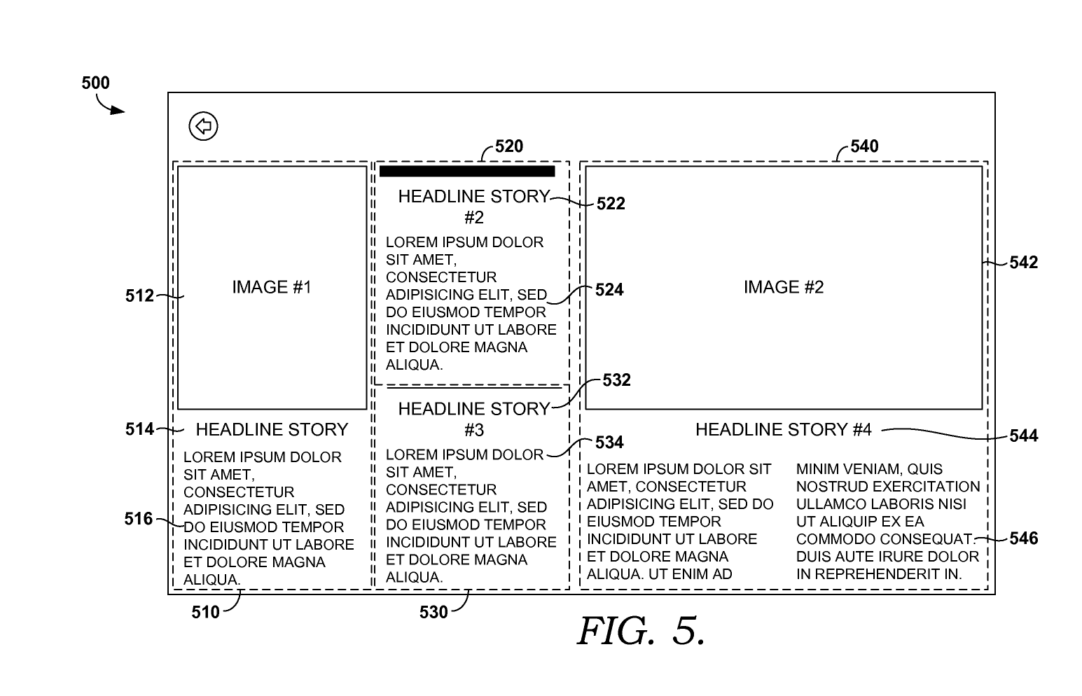

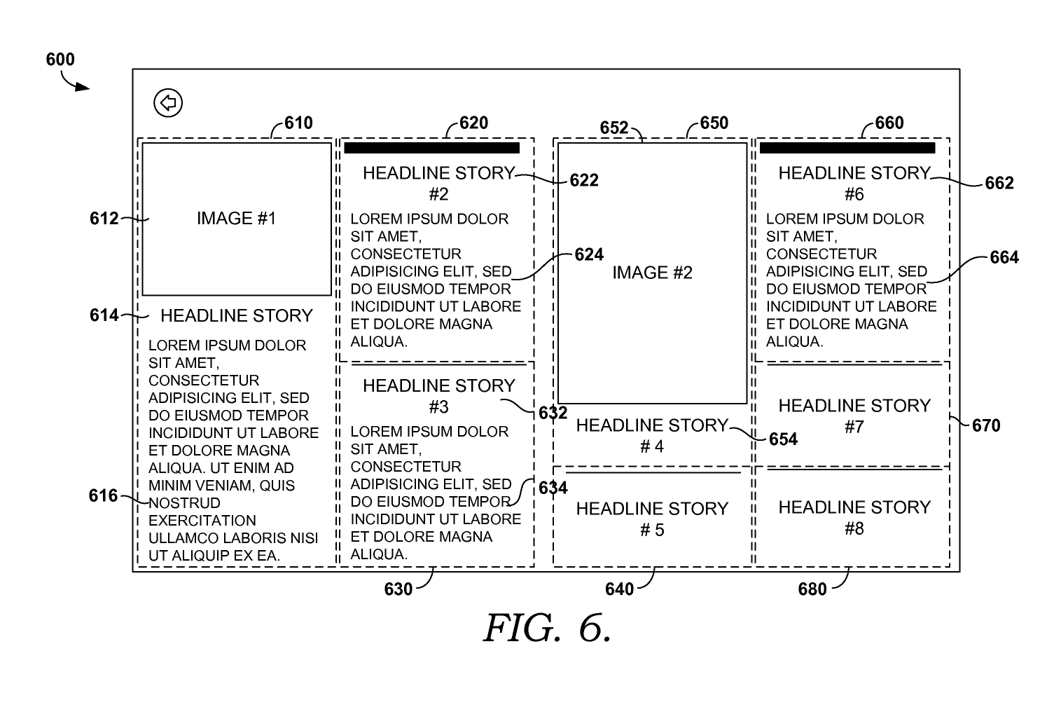

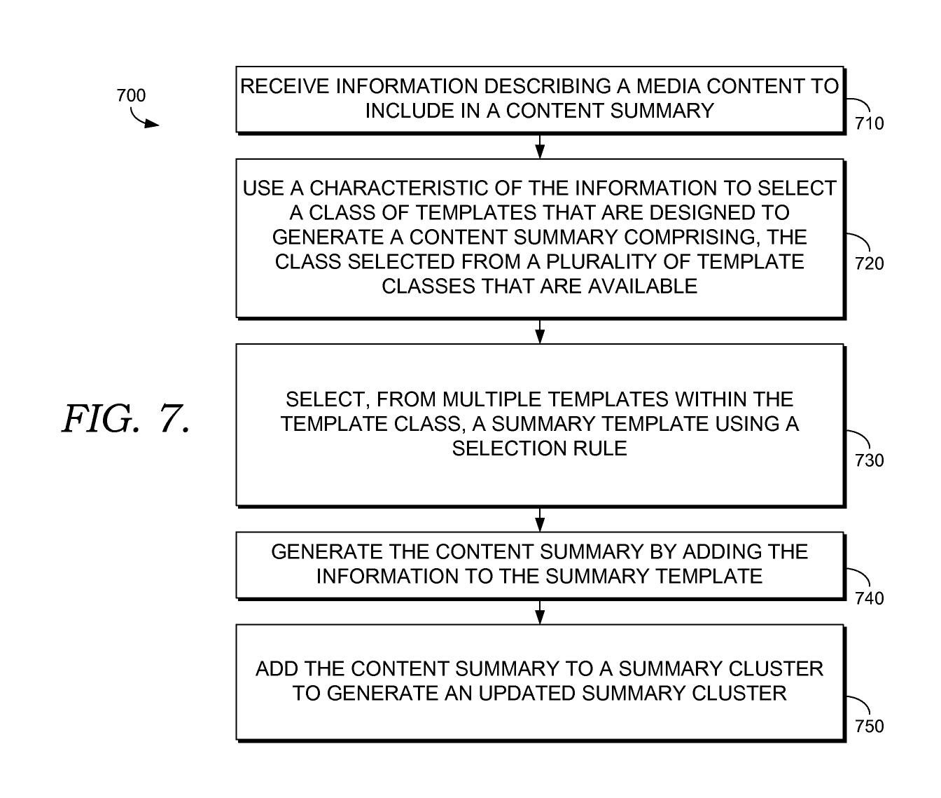

The client 320 includes a summary-cluster component 322 and a content-layout component 324. The summary-cluster component 322 builds a summary cluster, which is a summary of available content, such as articles. The summary may include images, headlines, snippets, bylines, and other information describing available articles. The summary-cluster component 322 arranges the various summaries in a presentation that is displayed to the user. The summary cluster is formed using various rules that improve its appearance. Exemplary clusters are shown in FIGS. 5 and 6. Additional features of a summary-cluster component are explained with reference to FIGS. 4 and 7.

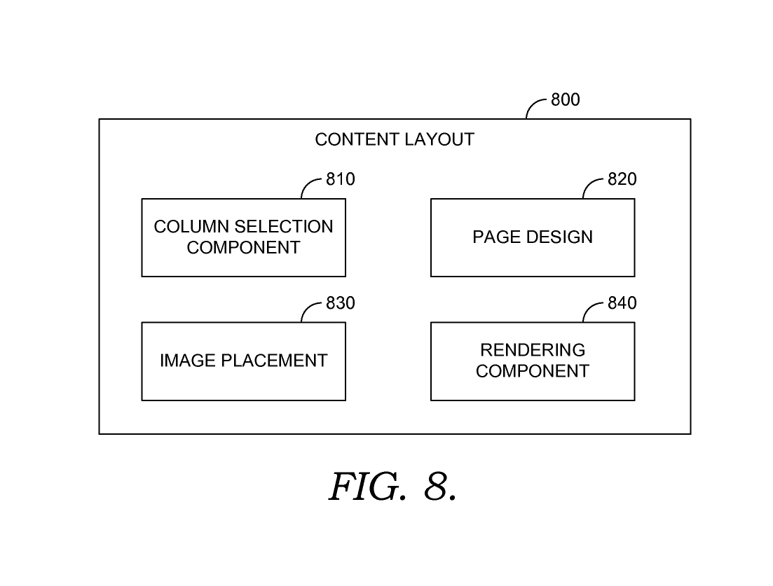

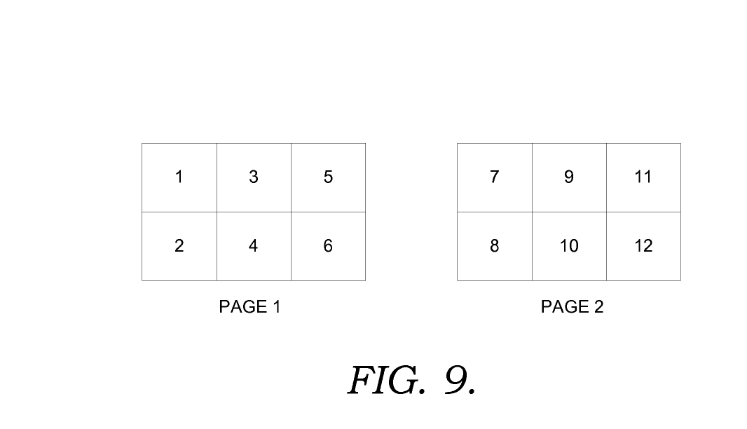

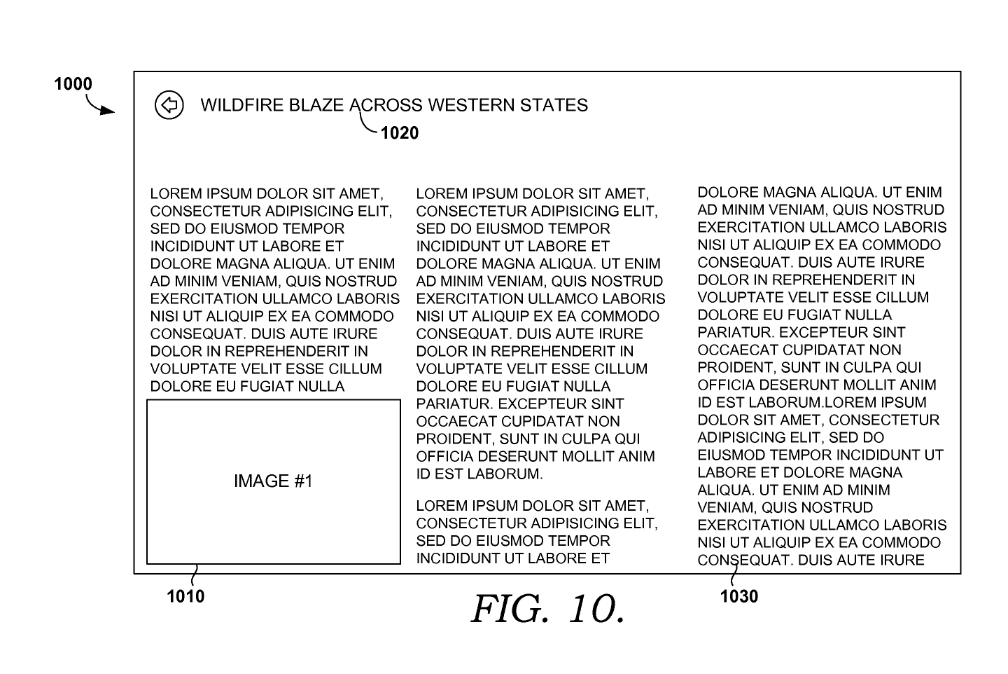

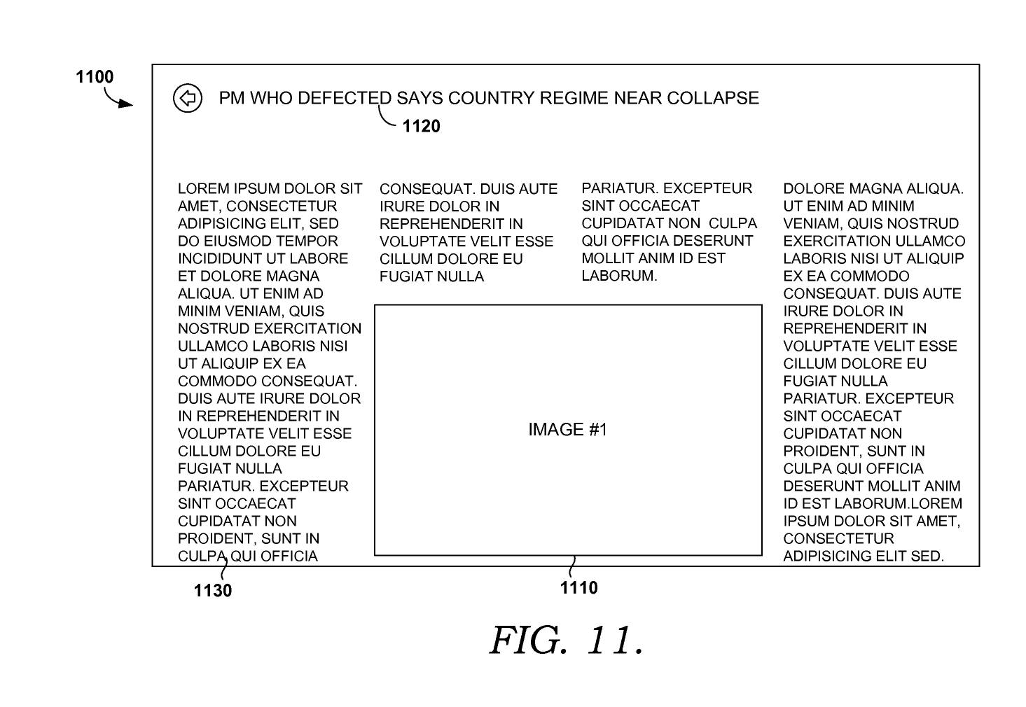

The content-layout component 324 dynamically builds a layout for displaying a selected article. Different layouts are possible based on the amount of text, media associated with the article, and a resolution of the display device. The content-layout component 324 may have access to various client 320 settings. The content-layout component 324 is able to dynamically build attractive article layouts for different screen resolutions and orientations. Exemplary content layouts are shown in FIGS. 10 and 11. An exemplary content-layout component is explained in more detail with reference FIGS. 8 and 9.

Turning now to FIG. 4, components of a summary-cluster component 400 is shown, in accordance with an embodiment of the present invention. These components are merely exemplary in nature and embodiments of the present invention are not limited to this arrangement of components and component functions. The content-cluster component 400 includes several groups of templates organized by class. The templates could be stored in a data store that is separate from the content-cluster component 400, but either way the content-cluster component 400 has access to the templates.

As shown, template class A 410 includes five templates, template class B 420 includes three templates, and template class C 430 includes four templates. The different template classes may have different amounts of templates within them. Within each class, the templates are suitable to display summary features that fit within the class. For example, templates in class A may be adapted to generate summaries that include an image falling within a certain size range. All of the templates within class A then would have the ability to display images within the associated range.

The class selection component 440 selects the class of template that should be used to generate an individual content summary. Again, a content summary includes various features that describe an associated content, such as a video or article. For example, the content summary features include an image, a snippet, a headline, a byline, a publication date, or other similar information describing an article.

The class selection component 440 selects the relevant class based on characteristics of the summary features. For example, the class may be selected based on image size, snippet size, or other characteristics. In this example, the image is the summary feature and the images size is the characteristic of the summary features. Similarly, the snippet is the summary feature and snippet size is the characteristic. Table 1 included below shows exemplary classes characteristics associated with different templates classes. Table 1 shows more than just template classes A, B, and C. Template classes A, B, and C have been shown in FIG. 4 for the sake of simplicity, but in an actual application numerous template classes may be possible.

TABLE 1

| | | | Image | |
|---|---|---|---|---|
| GA Class | | Image Size | Aspect | Snippet |
| Name | GA Class Type | (w × h) | Ratio | (chars) |
| Class A | Landscape Image | 610 × 406 | 3:2 | 200-250 |
| | (smaller snippet) | | | |
| Class B | Landscape Image | 610 × 406 | 3:2 | 650-800 |
| | (longer snippet) | | | |
| Class C | Portrait Image | 280 × 420 | 2:3 | 200-250 |
| | (smaller snippet) | | | |
| Class E | Square Image | 610 × 610 | 1:1 | 200-250 |
| | (smaller snippet) | | | |
| Class F | No Image (smaller | | | 100-150 |
| | snippet) | | | |
| Class G | No Image (smaller | | | 200-250 |
| | snippet) | | | |
| Class H | No Image (longer | | | 650-800 |
| | snippet) | | | |
| Class I | Square Image | 610 × 610 | 1:1 | 650-800 |
| | (longer snippet) | | | |
| Class S | Slideshow class | 590 × 393 | 3:2 | 100-150 |
| Class V | Video class | 680 × 440 | 3:2 | 100-150 |
| Class V1 | Heterogeneous | 680 × 440 | 3:2 | No |
| | video class | | | Snippet |
| Class V2 | Homogenous | 450 × 300 | 3:2 | No |
| | video class | | | Snippet |
| Class RS | Reuters Slideshow | 590 × 393 | 3:2 | 100-150 |
| Class Z1 | Magazine Square | 290 × 290 | 1:1 | 200-250 |
| | Image class | | | |
| Class Z2 | Magazine | 395 × 711 | 3:2 | 650-800 |
| | Landscape Image | | | |
| | class | | | |

As can be seen in Table 1, some classes are directed to different categories of contents. For example, Classes A, B, C, E, F, G, H, and I are directed to articles or similar content, while Class V, V1, and V2 are directed to videos and Class S is directed to slide shows. Using Table 1, for class A to be picked an image associated with a summary must be 610×406 and have a snippet with between 200 and 250 characters. Class F, G, and H are associated with templates that do not use images. The classes are organized based on likely characteristics of summary content. The characteristics shown above are just one example. Classes could be added or removed based on the characteristics of summary features used to build a summaries for content summarized in a summary-cluster.

The template selector 450 selects a template within the class previously chosen for the content summary. A number of factors may be considered by the template selection component 450 when selecting the template. Many of these factors relate to templates already used within a partially or fully constructed cluster. If this is the first article summary being built for a particular cluster, then the individual template could be selected at random. In another embodiment, individual templates are associated with a prominence level within the cluster. Articles that are thought to be of particular interest to a user associated with a client may be assigned preferentially to templates that have a more prominent display characteristic.

When other article summaries have already been built and are included within a summary cluster, then factors such as frequency of use overall within a cluster and adjacent templates may be considered. For example, a rule may state that the same template is not placed adjacent to each other. The frequency rule may state that a template is only used once per column or once every so many columns. A frequency rule could limit the use of a template to a designated number of times per summary cluster. For example, an individual template could be limited to one or two uses per cluster.

For the purposes of frequency rules and selection, though somewhat different, a type of template occurring in different classes could be considered the equivalent template. Even though some characteristics of the template would be different, for example, a template in class B 420 may be sized to accommodate a smaller image than the equivalent template in template class A 410, but they may have other similar stylistic characteristics and, therefore, be considered the same template for the purposes of the frequency rule and other rules utilized by the template selection component 450. The idea is to create a non-uniform arrangement of summaries within the cluster.

The cluster builder 460 builds the dynamic cluster from the templates selected previously. The cluster builder 460 may insert the content summary features into the selected templates and generate a rendered image of the summary cluster for display. In some devices, the dynamic cluster may change dynamically as a device is rotated from portrait to landscape mode.

Turning now of FIG. 5, an exemplary summary cluster 500 is shown, in accordance with an embodiment of the present invention. The summary cluster includes article summary 510, article summary 520, article summary 530, and article summary 540. As can be seen, the summary cluster comprises four columns.

Article summary 510 includes an image 512, a headline 514, and a snippet 516 summarizing the related article. Article summary 520 includes a headline 522 and a snippet 524. Article summary 520 also includes a bar near the top. Article summary 530 includes a headline 532 and a snippet 534. Article summary 540 consumes two columns and includes image 542, headline 544, and snippet 546.

Turning now to FIG. 6, a dynamic summary cluster 600 is shown, in accordance with an embodiment of the present invention. Similar to summary cluster 500, summary cluster 600 comprises four columns but includes a different arrangement of content summaries. The dynamic summary cluster 600 includes content summary 610, 620, 630, 640, 650, 660, 670, and 680.

Article summary 610 includes image 612, headline 614, and snippet 616. Article summary 620 includes headline 622 and snippet 624, along with a bar at the top. The article summary 630 includes a headline 632 and a snippet 634.

The article summary 650 includes image 652 and headline 654. Article summary 640 only includes a headline. Article summary 660 includes headline 662 and snippet 664. Article 670 includes a single headline, as does article summary 680.

Turning now to FIG. 7, a method 700 of generating a user interface for displaying a summary cluster is shown, in accordance with an embodiment of the present invention. An individual content summary describes a media content that is available for fuller display. An individual summary may comprise an image and a snippet describing the content. Other components of the summary are also possible. A plurality of content summaries may be arranged in a visually appealing summary cluster within a user interface. A user may select one of the summaries to retrieve a full version of the article. Embodiments of the invention different summary templates to build individual summaries so that a collection of summaries in a summary cluster will have a variety of shapes and sizes in an interesting arrangement.

At step 710, information describing in a media content is received. The information is used within a summary of the media content. Exemplary information includes an image, a snippet, a source, a publication date, a headline, and other relevant information. The media content may include a news article, an advertisement, a slide show, and a video.

At step 720, a characteristic of the information is used to select a class of templates that are designed to generate a content summary comprising information having the characteristic. The class is selected from a plurality of template classes that are available to generate content summaries. Other classes of templates are designed to build content summaries using information having different characteristics. For example, a first class of templates may be designed to accommodate a large image while a second class of templates may be designed to accommodate a small image. What might be considered a large or small image is illustrated in Table 1 described previously. Other definitions of small and large images are possible.

When an available image does not fit within any available class, then a best fit may be made. The best fit may take into account the closest available class or use a criteria such as the nearest class that does not require smaller content. For example, an image larger than any of the classes might be fit into the class associated with the largest images. In a subsequent step, the image could be cropped or scaled to fit into the summary associated with that class.

At step 730, a summary template is selected from the previously selected class. The template class has multiple templates that may be selected. A selection rule that considers other templates used to build an existing summary cluster is used to select the appropriate template. Exemplary selection rules limit the number of times a template may be used within a content summary interface.

At step 740, the content summary is generated by adding the information to the summary template. The summary template may comprise slots or blanks where the information may be inserted. For example, an image and snippet may be inserted into the summary template to build the content summary.

At step 750, the content summary is added to the existing summary-cluster to generate an updated summary-cluster comprising the content summary and a plurality of the different content summary. The update summary cluster is output for display to as user. In embodiments, the summary

Turning now to FIG. 8, a content-layout component 800 is shown, in accordance with an embodiment of the present invention. Content layout component 800 may be similar to content-layout component 324 described previously with reference to FIG. 3. The content-layout component 800 may reside on a client device and generates a layout for media content and may be viewed on the device. The content-layout component 800 is designed to work with various display resolutions and characteristics. In addition to a screen's overall resolution, less than the entire screen may be available for a particular article display. In some devices, the article display may change dynamically as a device is rotated from portrait to landscape mode. Either way, the content layout component 800 is capable of dynamically generating an appropriate layout for display. The content layout component 800 includes a column selection component 810, a page design component 820, image placement 830, and a rendering component 840.

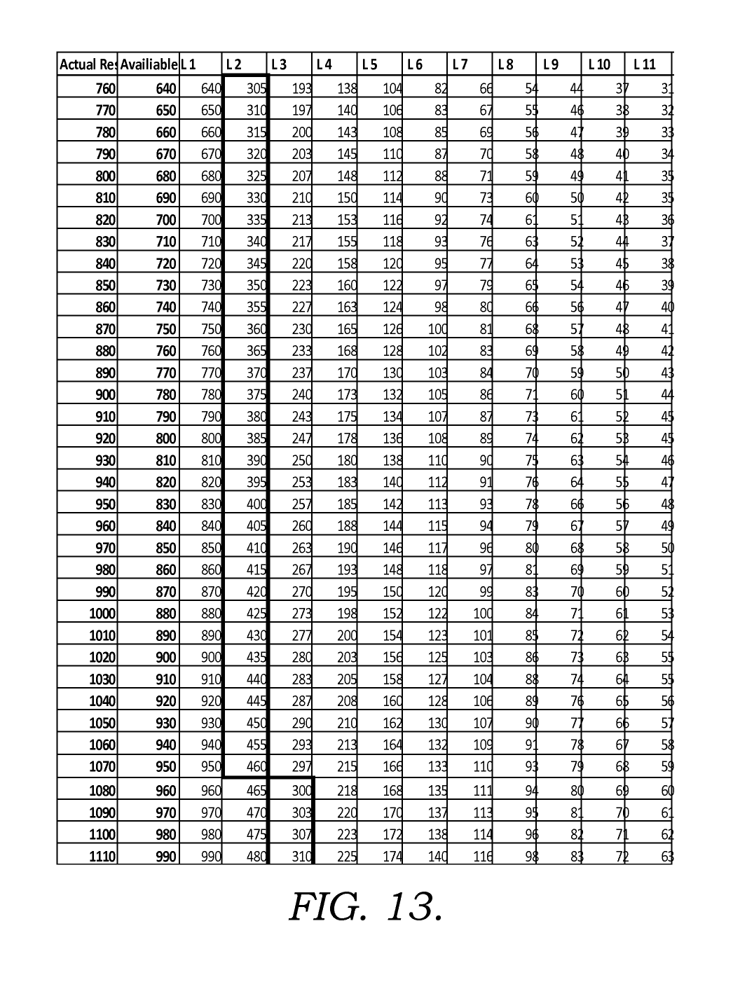

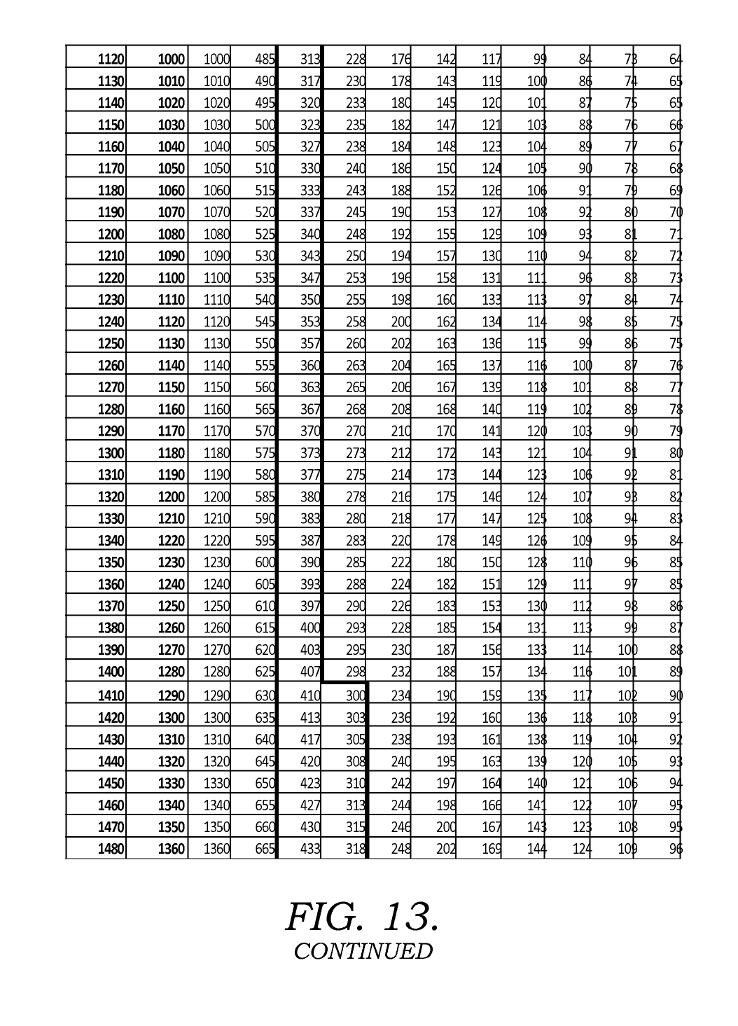

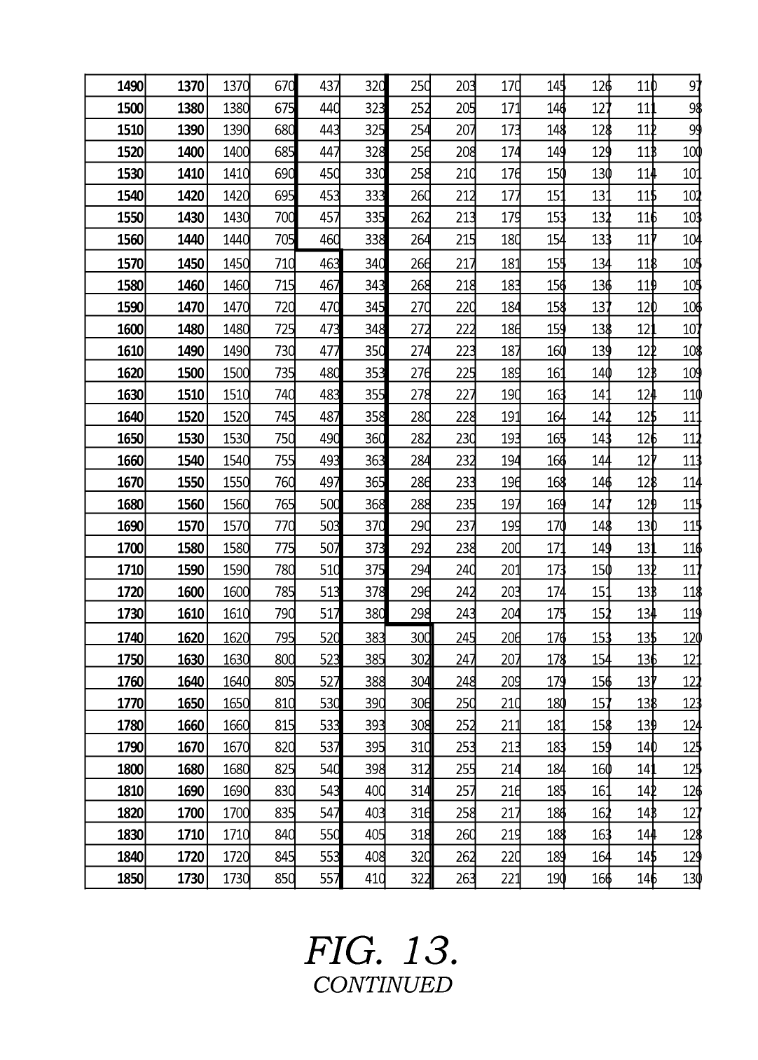

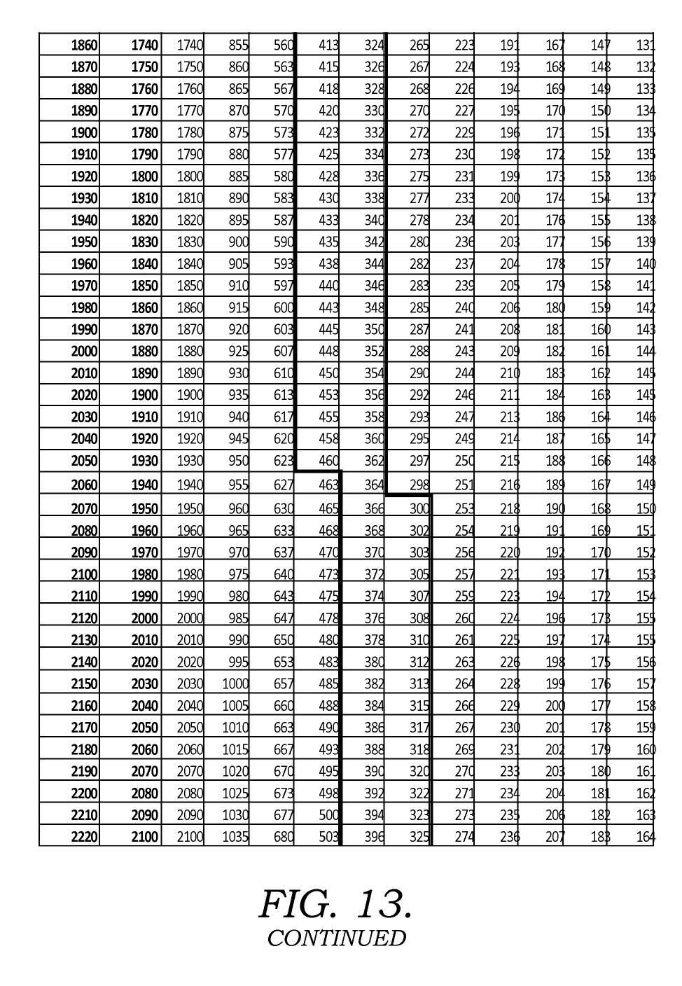

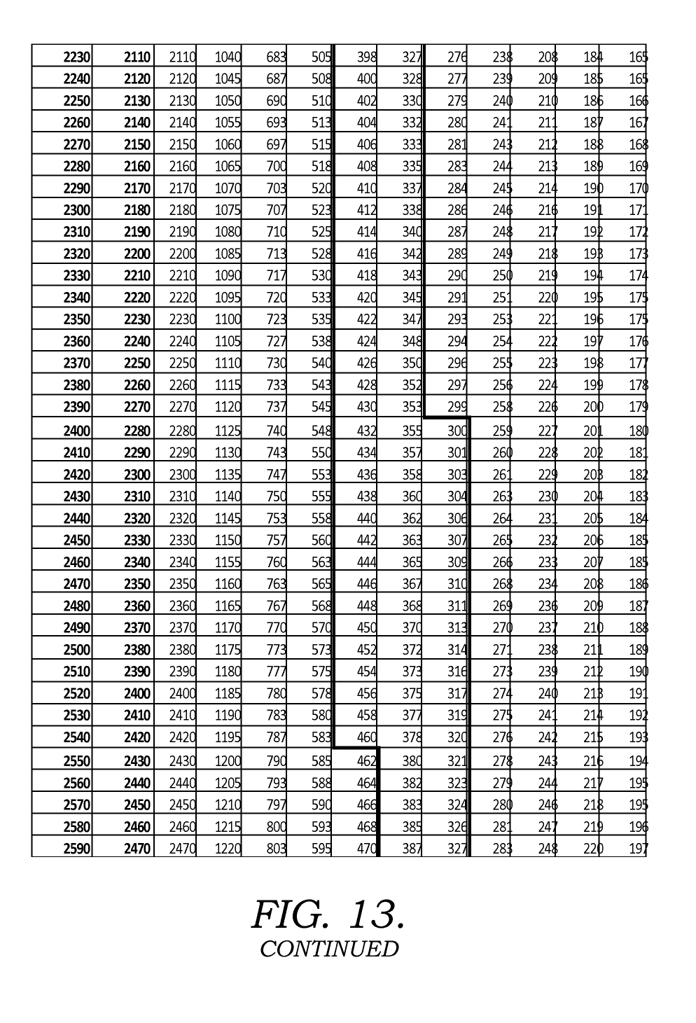

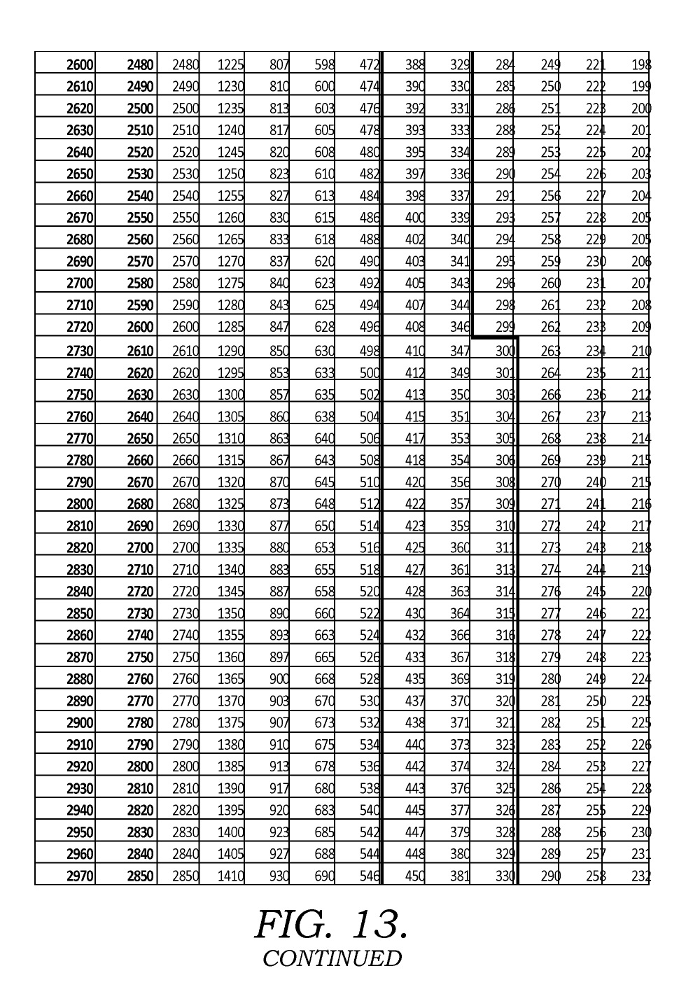

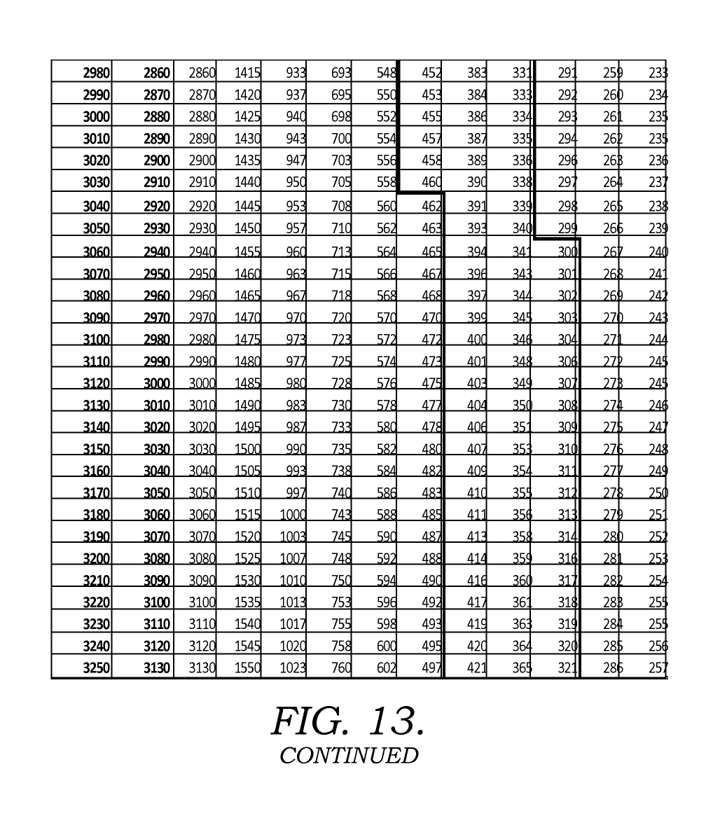

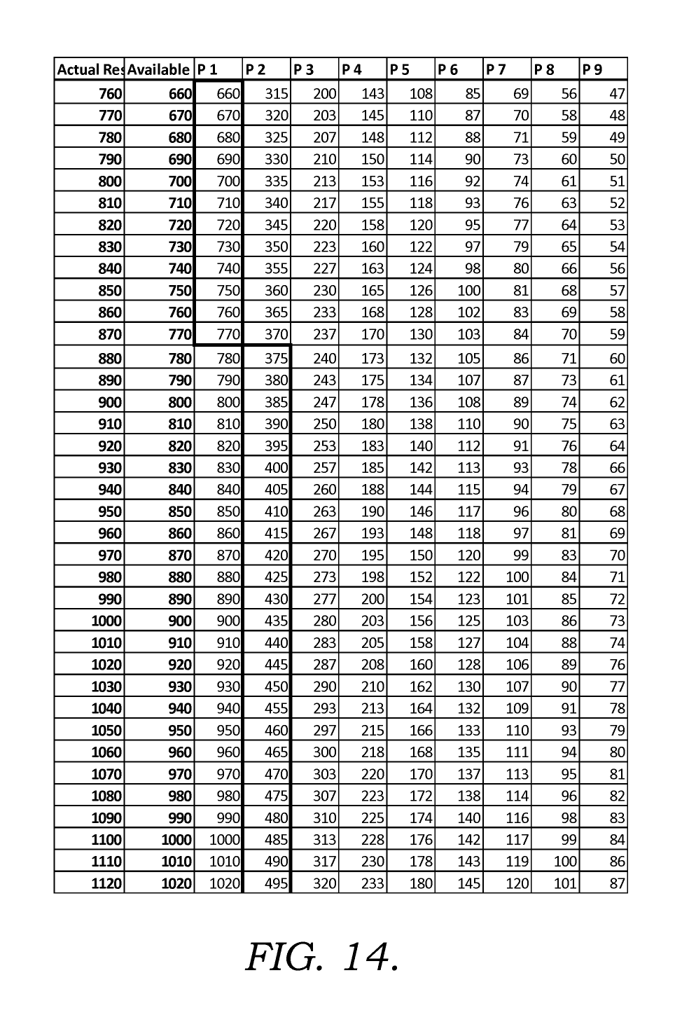

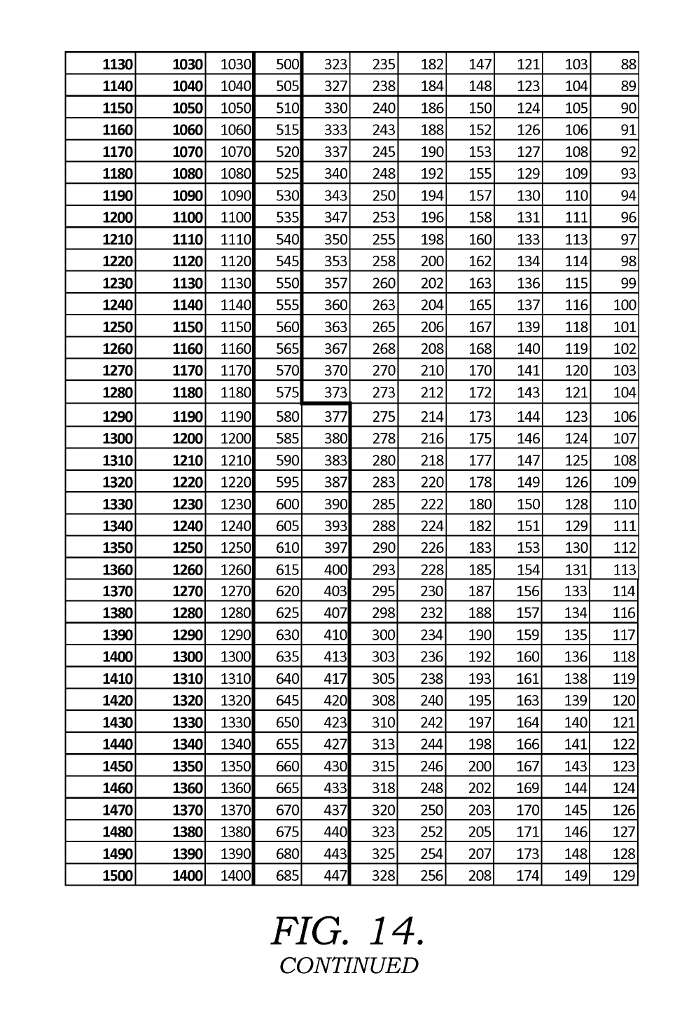

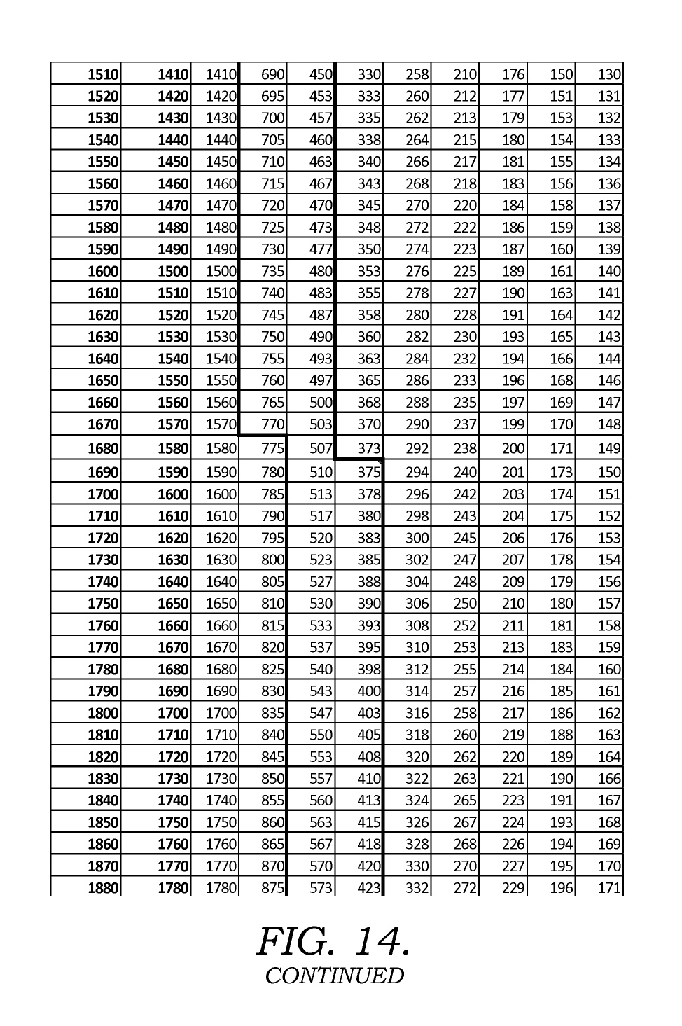

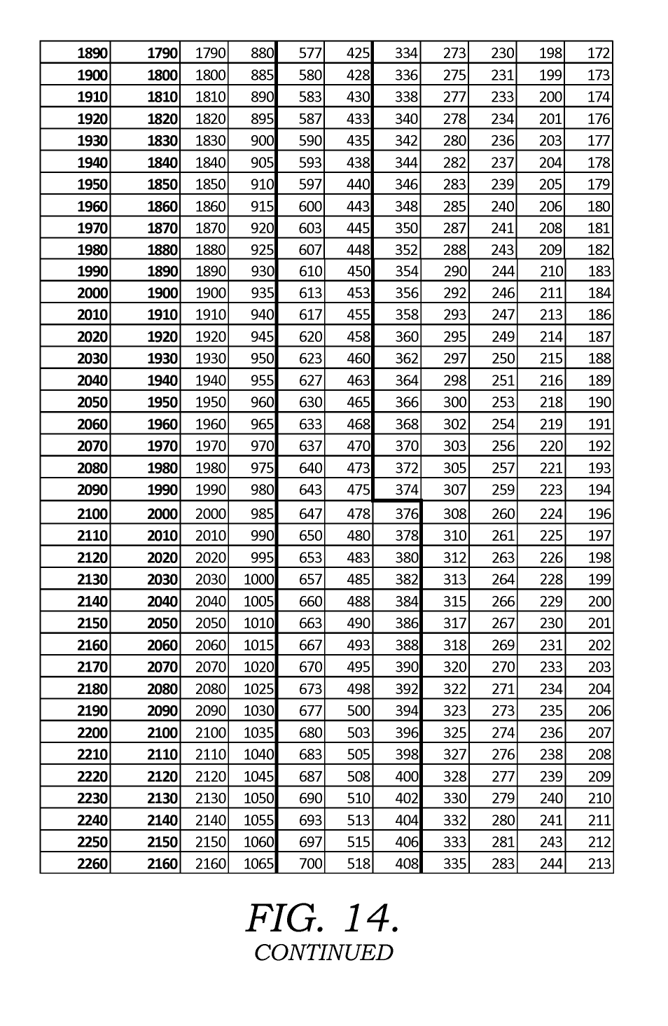

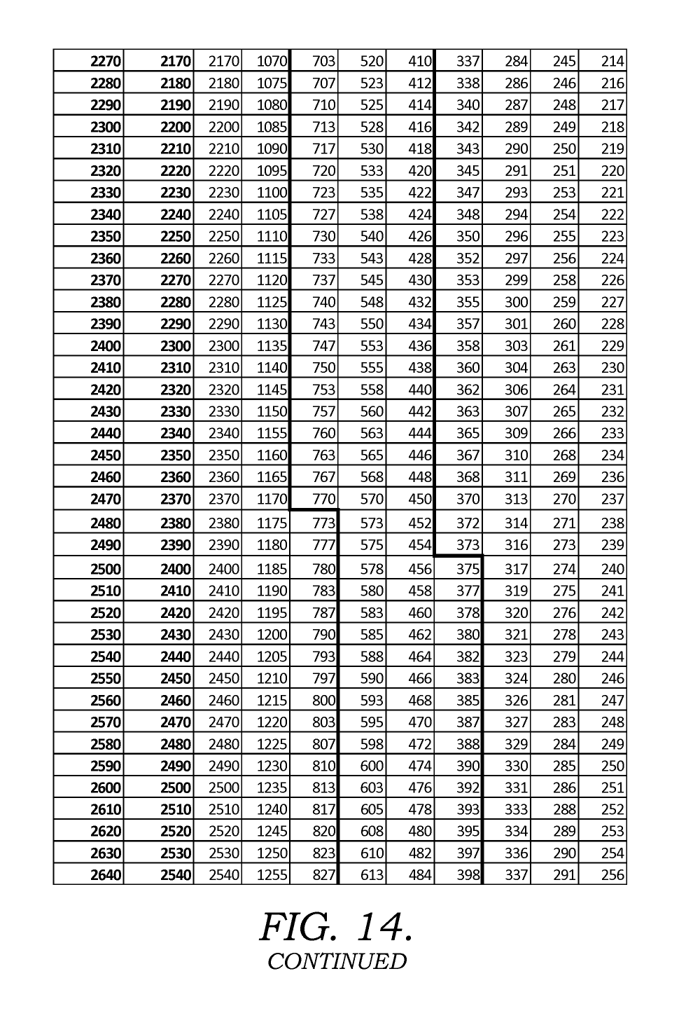

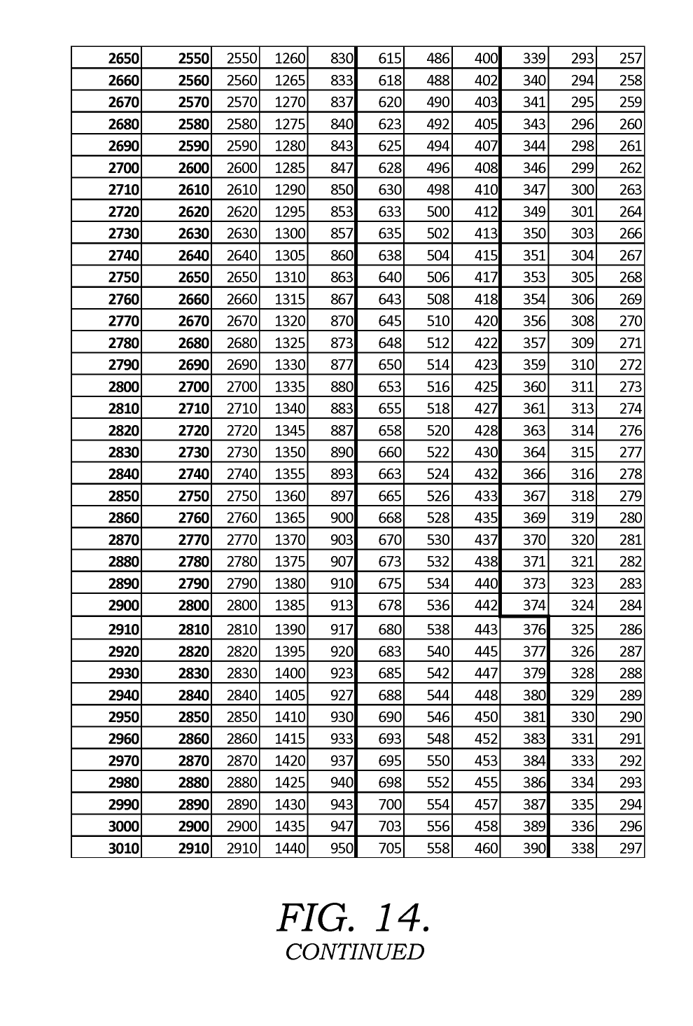

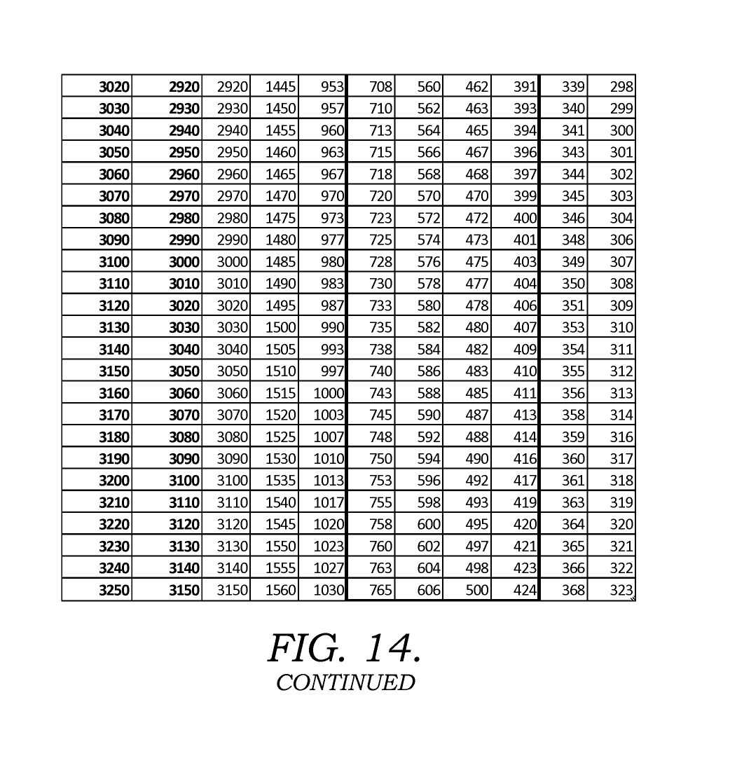

The column selection component 810 selects an appropriate column width given the available display area. In one embodiment, the columns may be selected based on the width of the available display area. In one embodiment, column width is kept between 300 and 460 pixels when in a landscape orientation and between 375 and 770 pixels when in a portrait orientation. FIGS. 13 and 14 show a chart that may be used to select the appropriate column width and how many columns will be presented. In some cases, a column width could be selected that would result in different numbers of columns. For example, if a display is 1,290 pixels wide, you could have three columns that are 410 pixels wide or four columns that are 300 pixels wide. These numbers allow for some room in between columns as well as margins on the side. For example, in one embodiment a column margin if 30 pixels is allowed for each column.

Once the size and number of ideal columns is selected by column selection component 810, then content is placed within the layout. The page design component 820 determines how many pages and associated columns will be necessary to present all of the text and media within an article. In one embodiment, a single selected column is populated with text from the article. The total number of characters that fit into the column are counted. The total number of columns is then calculated by dividing the total characters in the article by the number of characters fit into the first column. Next, the number of columns consumed by images or other media associated with the article is calculated and added to the number of columns needed to present the text. This will result in the total number of columns required.

Next, the total number of pages required is determined by dividing the total columns required by columns per page.

Next, the image placement component 830 places images throughout the available columns. The images are place according to their size (aspect ratio). Turning briefly to FIG. 9, an image could be placed in column 4 on page 1 and in column 11 shown on page 2. Notice that the columns are segregated into sections. The first column on page 1 includes section 1 and 2, the second column includes sections 3 and 4, and the third column includes sections 5 and 6. Page 2 is similar. While this example divides the columns in half, other partitions are possible. The partitions may be dynamically selected based on the size of available media. For example, if the media to be presented along with the text takes up half a column, then dividing the columns in half may be appropriate. On the other hand, if the available screen space is such that the images take up a quarter of a column, then the columns may be segregated into four sections.

Returning to FIG. 8, the image placement component 830 places images throughout the available pages and then flows text around the images to build the final page. The images are place according to their size (aspect ratio) and text and other content is placed in relation to the image placement. In embodiments of the present invention, the entire article comprising multiple pages may be built and rendered by rendering component 840 at once rather than in individual steps.

Turning now to FIG. 10, an exemplary article display 1000 is shown, in accordance with an embodiment of the present invention. As can be seen, the article display comprises three columns. The article display includes a title 1020, an image in the first column 1010, and text 1030.

Turning now to FIG. 11, an exemplary article layout 1100 is shown, in accordance with an embodiment of the present invention. The article layout 1100 includes an image 1110, a title 1120, and text 1130. Notice that the article layout 1100 includes four columns and the image consumes the lower portion of the two middle columns.

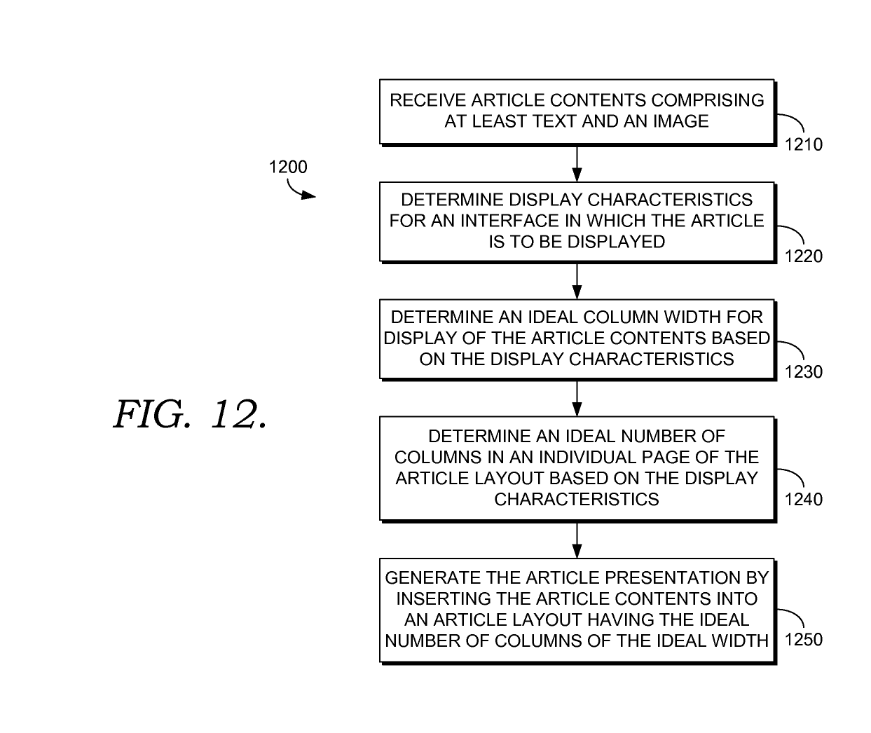

Turning now to FIG. 12, a method 1200 of generating an article layout is shown, in accordance with an embodiment of the present invention. An article layout receives article content to form an article display. The article display may be output to a display device to allow the user to read an article.

At step 1210, article content comprising at least text and an image are received. The contents may also comprise slideshows and videos as well. The contents may be received from a content manager described previously.

At step 1220, display characteristics for an interface in which the article is to be displayed are determined. Display characteristics may comprise the width of the interface. The width may be measured in pixels. The orientation of the interface is another display characteristic. The interface may be an entire screen or a part of the display if the interface is displayed within a window, for example.

At step 1230, an ideal column width for display of the article content is determined based on the display characteristics. At step 1240, an ideal number of columns in an individual page of the article layout is determined based on the display characteristics. Exemplary column numbers and column widths are shown below in FIG. 13. FIG. 13 comprises a table showing

These widths are merely exemplary, and variations could be used in other embodiments of the present invention. At step 1250, the article presentation is generated by inserting the article content into an article layout having the ideal number of columns of the ideal width. In one embodiment, the article presentation is several pages long and the contents, including text and images, are inserted at one time to generate a multi-page document. The presentation may be presented one page at a time. In one embodiment, the images are placed first within the available columns and the text is inserted around it.

Turning now to FIG. 13, a table 1300 showing column widths that would result when a landscape oriented device is divided into one to nine columns, according to an embodiment of the present invention. Various interface resolutions are indicated in the actual resolution column 1310. The available resolution is indicated in column 1312. The available resolution is calculated by subtracting space allocated to margins between columns and on the side from the actual resolution. The available resolutions shown are merely exemplary and could change depending on the preferred margin settings. Columns 1314, 1316, 1318, 1320, 1322, 1324, 1326, 1328, and 1330 each show the width of the column that would result from dividing the interface into that number of columns, taking into account room for margins. For example, column 1416 shows that the width of each column give an 890 pixel resolution (width) would be 380 pixels.

Table 1300, which continues for several pages shows a blocked area delineated on the left by line 1340 and on the right by line 1342. Column widths shown in blocked area satisfy a selection criteria designated within an embodiment of the present invention. In some cases, only one column width is available for a particular resolution. In other examples, multiple column widths meet the criteria. A selection function may be used when multiple column widths falling within the selection criteria are available. In one embodiment, the size of images to be inserted into the display are considered. A column width that best fits the images is selected using the selection function.

Turning now to FIG. 14, a table 1400 showing column widths that would result when the landscape oriented display is divided into various numbers of columns is shown, in accordance with an embodiment of the present invention. Column 1410 lists actual available width based on the device resolution in portrait mode. The available width, which takes into consideration room for margins, is shown in column 1412. The remaining columns, 1414, 1416, 1418, 1420, 1422, 1424, 1426, 1428, and 1430, each designate the available width of a column when the available width is divided among the number of columns indicated in the respective column. The column widths falling into a preferred range in an embodiment of the present invention are designated in a block delineated on the left by line 1440 and on the right by line 1442.

Embodiments of the invention have been described to be illustrative rather than restrictive. It will be understood that certain features and sub-combinations are of utility and may be employed without reference to other features and sub-combinations. This is contemplated by and is within the scope of the claims.

The invention claimed is:

1. One or more computer-storage media having computer-executable instructions embodied thereon that when executed by a computing device perform a method of generating a user interface for displaying a plurality of content summaries, the method comprising:
receiving information describing a media content, the information formatted for use in a content summary, which is a modular summary of the media content that is sized and shaped to be part of a summary cluster, which includes multiple content summaries;
using a characteristic of the information to select a class of templates that are used to generate the content summary, the class selected from a plurality of available template classes;
selecting, from multiple templates within the class, a summary template using a selection rule;
generating the content summary by adding the information to the summary template; and
adding the content summary to the summary cluster.

2. The media of claim 1, wherein the selection rule specifies that an individual template may only be used once to build content summaries every designated number of columns within a summary cluster.

3. The media of claim 1, wherein the selection rule specifies that summaries built from an individual group of templates appears only once every designated number of columns within the summary cluster.

4. The media of claim 1, wherein the selection rule prohibits content summaries of the same size to be adjacently located.

5. The media of claim 1, wherein the information is an image and the characteristic is a size of the image.

6. The media of claim 1, wherein the information is a snippet comprising text describing the media content and the characteristic is a length of the snippet.

7. The media of claim 1, wherein the media content is one or more of an article, a video, a slideshow, and an advertisement.

8. One or more computer-storage media having computer-executable instructions embodied thereon that when executed by a computing device perform a method of generating an article layout, the method comprising:
receiving an article content comprising at least text and an image;
determining a display characteristic of an interface in which an article is to be displayed;
determining an ideal column width for display of the article content based on the display characteristic;
determining an ideal number of columns in an individual page of the article layout based on the display characteristic; and
generating an article presentation by inserting the article content into the article layout having the ideal number of columns of the ideal column width.

9. The media of claim 8, wherein the display characteristic is a width of the interface in which the article is to be displayed.

10. The media of claim 8, wherein the ideal column width for a landscape oriented interface is between 300 and 460 pixels.

11. The media of claim 8, wherein the ideal column width for a portrait oriented interface is between 375 and 770 pixels.

12. The media of claim 8, wherein the inserting the article content into the article layout comprises inserting the image first according to image size and placing the text in relation to the image.

13. The media of claim 8, wherein the article layout comprises multiple pages and the article content is inserted into all pages before additional pages are ready for display.

14. The media of claim 8, wherein a total number of pages within the article layout is calculated by determining an amount of characters from the text fit into a single column, dividing total characters in the text by the amount of characters that fit in the column, and then adding columns needed to present images within the article content.

15. A method of generating a user interface for an application running on a client device, the method comprising:
receiving an image and a snippet describing an article, the image and the snippet formatted for use in a content summary, which is a modular summary of the media content that is sized and shaped to be part of a summary cluster, which includes multiple content summaries;
using a characteristic of the image and the snippet to select a class of templates that are designed to generate the content summary for the article, the class selected from a plurality of available template classes;
selecting a summary template for the class using a selection rule that considers as input other content summaries in an existing summary cluster to which the content summary will be added;
generating the content summary by adding the image and the snippet to the summary template;
adding the content summary to the existing summary cluster; and
receiving a selection of the content summary.

16. The method of claim 15, further comprising:
receiving a selection of content summary;
receiving article content comprising at least text and an image;
determining a display characteristic for an interface in which an article is to be displayed;
determining an ideal column width for display of the article content based on the display characteristic;
determining an ideal number of columns in an individual page of the article layout based on the display characteristic; and
generating an article presentation by inserting the article content into the article layout having the ideal number of columns of the ideal column width.

17. The method of claim 16, wherein said wherein the display characteristic is a width of the interface in which the article is to be displayed.

18. The method of claim 15, wherein the characteristic is a size of the image.

19. The method of claim 15, wherein the characteristic is a length of the snippet.

20. The method of claim 15, wherein the selection rule specifies that summaries built from an individual template appears only once every designated number of columns within the summary cluster.
